(19) United States
(12) Patent Application Publication
(10) Pub. No.: US 2006/0005592 A1
(43) Pub. Date: Jan. 12, 2006

(54) Manipulation-resistant combination lock

(76) Inventors: Charles W. Moon, Colorado Springs, CO (US); Michael J. Wright, Santa Ana, CA (US); Ernst Kern Mitchell, Sterling Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/886,375

(22) Filed: Jul. 7, 2004

(51) Int. Cl. E05B 37/08

(52) U.S. Cl. 70/303 A

(57) ABSTRACT

A combination lock includes various features that make the lock manipulation-resistant. The lock has a rocker arm with a curved underside section that contacts a roller on a cam that rotates when the lock dial is rotated. The smooth curve and an angled contact portion on the rocker arm causes the force applied to the rocker arm by the roller to be gradual rather than abrupt, ensuring that the contact point between the rocker arm and the roller is unpredictable. The lock may also include various spring-biased relocking devices that are biased away from the travel path of the bolt when the back cover is attached to the housing. The biasing force in the relocking device causes the device to move into the travel path of the bolt when the back cover is displaced or removed, preventing the bolt from moving to an unlocked position. The lock may also include a toothed washer having a trapezoidal tooth and a corresponding trapezoidal notch in a tube in the lock housing to eliminate transfer of rotation from one wheel to another. The trapezoidal shapes eliminate air gaps between the tooth and the notch, tightening the dial span of the lock.

### TECHNICAL FIELD

The present invention relates to combination locks, and more particularly to a combination lock having a structure that resists manipulation.

### BACKGROUND OF THE INVENTION

Combination lock structures, particularly those that are used in safes, must be designed to resist unauthorized manipulation. Knowledgeable locksmiths may pick combination locks by removing a dial, spindle and back cover plate of the lock and then using tools to manipulate the tumbler wheels in the lock or by slowly rotating the combination dial and observing the effects of the rotation (e.g., by feel, by listening to clicks in the lock, and/or by visual observation of a laser beam directed on the lock).

The combination dial is attached to a cam wheel having a roller that rides along an underside of a rocker arm. The rocker arm is made of metal and is attached to a lock housing via a screw. The cam wheel operates a plurality of tumbler wheels that each have a gate. If the gates are aligned with each other, a notch in the cam wheel allows a protrusion in a lever arm to drop downward into the notch and a bar attached to the lever arm to drop into the aligned gates, freeing a latch bolt to move into an unlocked position.

The cam wheel has a roller fastened to it. The roller rides against an underside of the rocker arm, which is coupled to the lever arm via a spring, to pull the second arm downward and move the protrusion toward the notch. As noted above, if the gates are also aligned with each other and the lever arm, the protrusion drops completely into the notch on the cam wheel, freeing the bolt. Ideally, the roller and rocker arm also hold the lever arm free of the cam wheel if the gates are not aligned; however, because cam wheels tend not to be perfectly round, the protrusion may ride on at least part of the circumference of the cam wheel, allowing a locksmith to detect the position of the cam wheel. The friction between the rocker arm and the roller, as well as the rigid attachment of the rocker arm on the housing, provides further information about the position of the cam wheel, making the lock easier to crack.

There is a desire for a combination lock that can resist manipulation without increasing the complexity of the lock structure.

### SUMMARY OF THE INVENTION

The present invention is directed to a combination lock having various features that make the lock manipulation-resistant. In one embodiment, the combination lock has a rocker arm with a curved underside section that contacts a roller on a cam that rotates when the lock dial is rotated. The smooth curve and an angled contact portion on the rocker arm causes the force applied to the rocker arm by the roller to be gradual rather than abrupt, obscuring the contact point between the rocker arm and the roller. A spring may support the rocker arm against the lock housing to allow both translational and rotational movement of the rocker arm. The rocker arm structure and the spring cause a fence on a lock lever to contact wheels in the lock in an unpredictable manner.

The lock may also include various spring-biased relocking devices. The springs in the relocking devices are biased away from the travel path of the bolt when the back cover is attached to the housing. In one embodiment, the relocking device is a torsional spring attached to the housing. The torsional spring is held against its biasing force by a tab that protrudes through the housing. In another embodiment, the relocking device is a linear spring having a contact portion on the first end and a second end that is lifted away from the travel path of the bolt when the contact portion is depressed by a projection on the back cover. The linear spring is disposed in a slot in the housing, making it inaccessible to locksmith tools. Regardless of the specific device configuration, removal or displacement of the back cover will release the relocking device, causing the spring biasing force in the device to move the device in the travel path of the bolt and prevent it from moving to an unlocked position.

In another embodiment, the inventive combination lock decreases the dial span of the lock by incorporating a toothed washer having a trapezoidal tooth and a corresponding trapezoidal notch on a tube that supports the wheels in the lock housing. The engagement between the tooth and the notch eliminates transfer of rotation from one wheel to another. The trapezoidal shapes eliminate air gaps between the tooth and the notch, tightening the dial span of the lock.

### BRIEF DESCRIPTION OF THE DRAWINGS

FIG. 1 is an exploded view of a combination lock according to one embodiment of the invention;

FIGS. 2A through 2D illustrate an operation of a rocker arm and roller in the lock of FIG. 1 according to one embodiment of the invention;

FIG. 3 illustrates first and second relocking mechanisms according to one embodiment of the invention, with the first relocking mechanism in a released state;

FIGS. 4A and 4B are section views illustrate the second relocking mechanism in a biased state and a released state, respectively;

FIGS. 5A and 5B are sectional perspective views illustrating the first relocking mechanism in a biased state and a released state, respectively; and

FIG. 6 is a representative diagram of a toothed washer according to one embodiment of the invention.

### DETAILED DESCRIPTION OF THE EMBODIMENTS

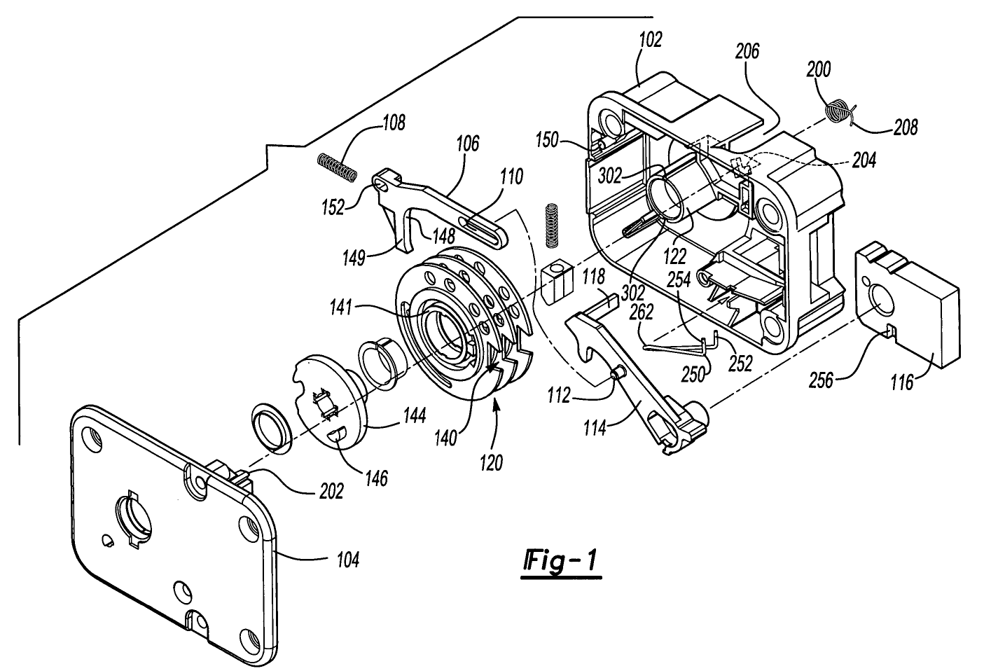

The combination lock according to one embodiment of the invention incorporates several features that simplify the structure as well as improve the lock's resistance to manipulation. For context, FIG. 1 illustrates the main components of a combination lock 100 according to one embodiment of the invention. Note that for clarity, not all of the figures will show every component in the lock 100.

The lock 100 contains a housing 102 and a back cover 104 to contain the lock components. The lock 100 includes a rocker arm 106 that is resiliently supported against the housing by a spring 108. The rocker arm 106 has a slot 110 that cooperates with a protrusion 112 on a lever 114 that drops downward when the lock is unlocked to release a bolt 116. As the lever 114 pivots and as the rocker arm 106 moves, the protrusion 112 slides in the slot 110. The cooperation between the protrusion 112 and the slot 110 eliminates the need for a separate spring to operably connect the rocker arm 106 to the lever 114.

The lever 114 has a fence 118 that rides on top of a plurality of wheels 120 that are mounted on a tube 122 formed in the housing 102. The wheels 120 are turned by rotating a numbered dial (not shown). Each wheel 120 also has a gate 140. When the wheels 120 are turned such that the gates 140 all align with each other and with the fence 118 on the lever 114, the fence 118 drops down into the gates 140, releasing the bolt 116 and allowing the bolt 116 to move to an open position. One or more toothed washers 141 may be included to engage the tube 122 to hold non-rotating wheels 120 in place as one wheel 120 is rotating.

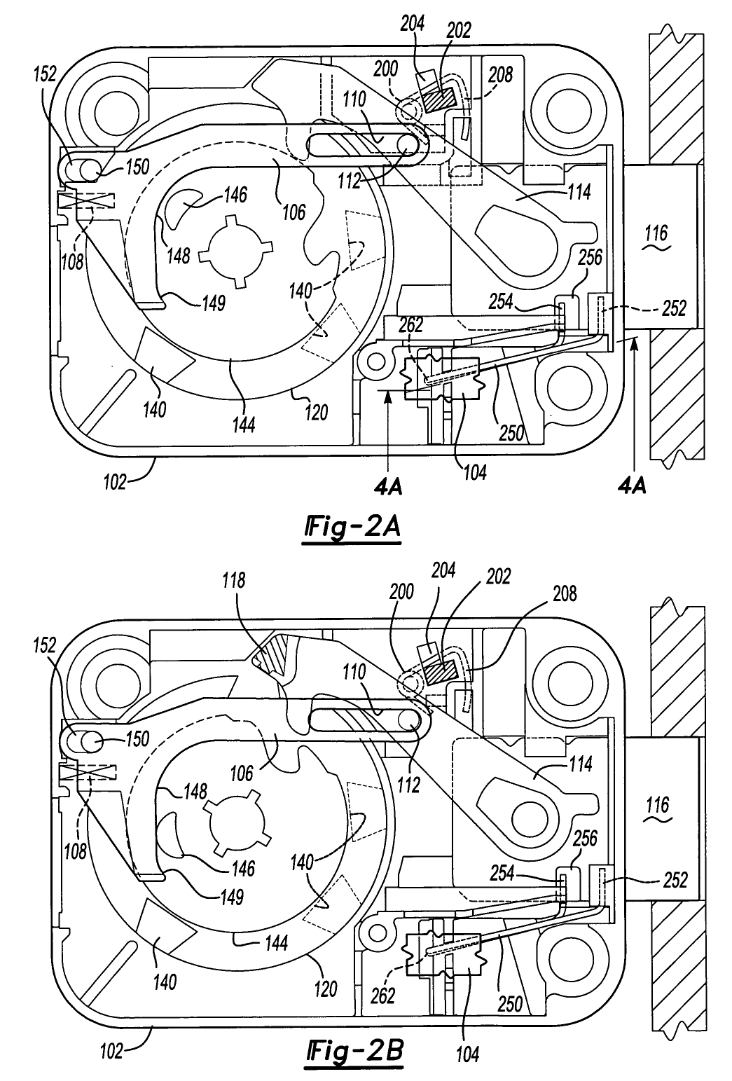

Rotation of the dial causes a cam 144 to rotate, thereby causing the wheels 120 to selectively rotate depending on the dial position and rotational direction. As shown in FIGS. 2A through 2D, the cam 144 has a roller 146 attached to or integrally formed thereon that contacts the rocker arm 106 as the cam 144 rotates. The rocker arm 106 moves slightly when the roller 146 contacts a curved underside section 148 of the rocker arm 106, lifting the lever 114 slightly away from the wheels 120 to provide a smooth feel and obscure the positions of the wheels 120 as they are rotated (FIGS. 2A through 2C). The underside of the rocker arm 106 is curved smoothly to obscure the contact point between the rocker arm 106 and the roller 146.

Also, the spring 108 forces the rocker arm 106 upward when the roller 146 does not contact the rocker arm 106, forcing the lever 114 upward away from the wheels 120. Lifting the lever 114 prevents contact between the fence 118 and the wheels 120, making it impossible to test the locations of the gates 140 by riding the fence 118 along the wheels 120 as the wheels 120 rotate or by rotating the dial to detect when then fence 118 contacts the wheels 120. Instead, the fence 118 drops downward only once per revolution of the cam 144, when the roller 146 contacts the rocker arm 106. Moreover, when the fence 118 does drop downward, the lost motion provided by the spring 108 prevents the fence 118 from contacting the same points on the wheels 120 during each revolution and in both rotational directions, further obscuring the positions of the gates 140 at any given time.

More particularly, the curved underside section 148 has a slightly angled portion 149 at a end contact point at which the rocker arm 106 makes initial contact with the rocker arm 106 when the cam 144 is rotating clockwise. The roller 146 will contact the angled portion 149 of the rocker arm 106 at an angle, rather than straight on, causing the force applied to the rocker arm 106 by the roller 146 to be gradual rather than abrupt. This gradual contact between the rocker arm 106 and the roller 146, caused by the angled portion 149 of the curved underside section 148, introduces an error in the rocker arm movement by constantly changing the leverage force on the rocker arm 106 each time the roller 146 makes contact.

This error makes it more difficult to detect the wheel 120 position, and therefore the lock combination, via physical feedback at various lock dial positions.

In one embodiment, the rocker arm 106 is made out of plastic instead of metal. The natural lubricity of the plastic eliminates the need for a multi-part roller assembly and smoothes the movement of the roller 146 or any other similar structure against the rocker arm 106. Further, the rocker arm 106 can be made flexible to further make the movement of lock components smoother and to provide additional range of motion.

As noted above with respect to FIG. 1, the rocker arm 106 is movably coupled to the housing 102 by a spring 108. The housing 102 also has a pin 150 that is disposed in an oval-shaped opening 152 in the rocker arm 106. This oval-shaped opening 152 offers an escapement structure to absorb any motion caused by rotation of the cam 144 and the resulting contact with the roller 146. In one embodiment, the spring 108 and pin 150 allow the rocker arm 106 to translate as well as rotate as the roller 146 contacts the rocker arm 106. This play in the rocker arm 106 caused by the spring 108, either alone or combined with the curved underside portion 148, ensures that the roller 146 gradually applies force to the rocker arm rather than abruptly moving the rocker arm 106 upon contact. The error in the rocker arm 106 movement caused by the spring 108 and the curved underside portion 148 makes it much harder to predict when the rocker arm 106 will actually start moving upon contact with the roller 146, thereby reducing any physical feedback information that locksmiths can use to deduce the positions of the gates 140.

This structure reduces the total number of lock components in the lock and provides a more secure operable connection between the rocker arm 106 and the lever 114. Further, because the slot 110 provides a lower range of motion for the lever 114, the protrusion 112 on the lever 114 reliably holds the lever 114 away from the wheels 120 to minimize or eliminate contact between the fence 118 and the wheels 120 until the fence 118 drops to test for aligned gates 140, allowing the bolt 116 to move to an open position (FIG. 2D). This eliminates further potential physical feedback information from the locksmith regarding the positions of the gates 140.

As shown in the Figures, the inventive combination lock may also include a torsional spring 200 disposed on a front surface of the housing 102, near the top of the lock 100. The torsional spring 200 acts as a relocking mechanism that is biased to block the lock bolt 116 from moving into an open position when the back cover 104 of the lock is removed or displaced from the housing 102, releasing the torsional spring 200.

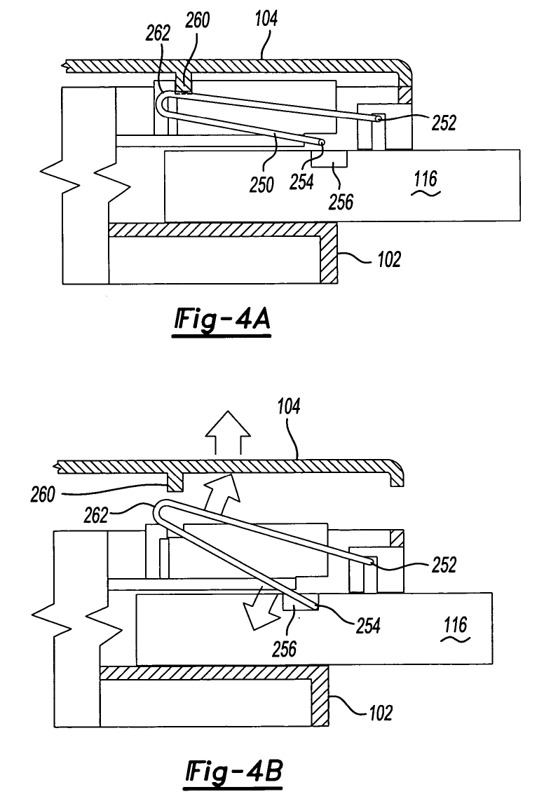

More particularly, as shown in FIG. 5A, the back cover 104 has a tab 202 that fits into a slot 204 in the housing 102. The torsional spring 200 is disposed in a recessed portion 206 on the front of the lock housing near the slot 204 so that is inaccessible to locksmith tools. When the back cover 104 is attached to the housing 102, the tab 202 projects into the slot 204 to hold the torsional spring 200 against its biasing force so that a leg portion 208 is held away from the travel path of the bolt 116. As a result, the bolt 116 is allowed to move freely between the locked and unlocked positions if the gates 140 in the wheels 120 are properly aligned and the lever 114 drops down to release the bolt 116. Thus, as long as the back cover 104 is properly attached to the housing 102, the tab 202 in the back cover 104 will hold the torsional spring 200 away from the bolt path.

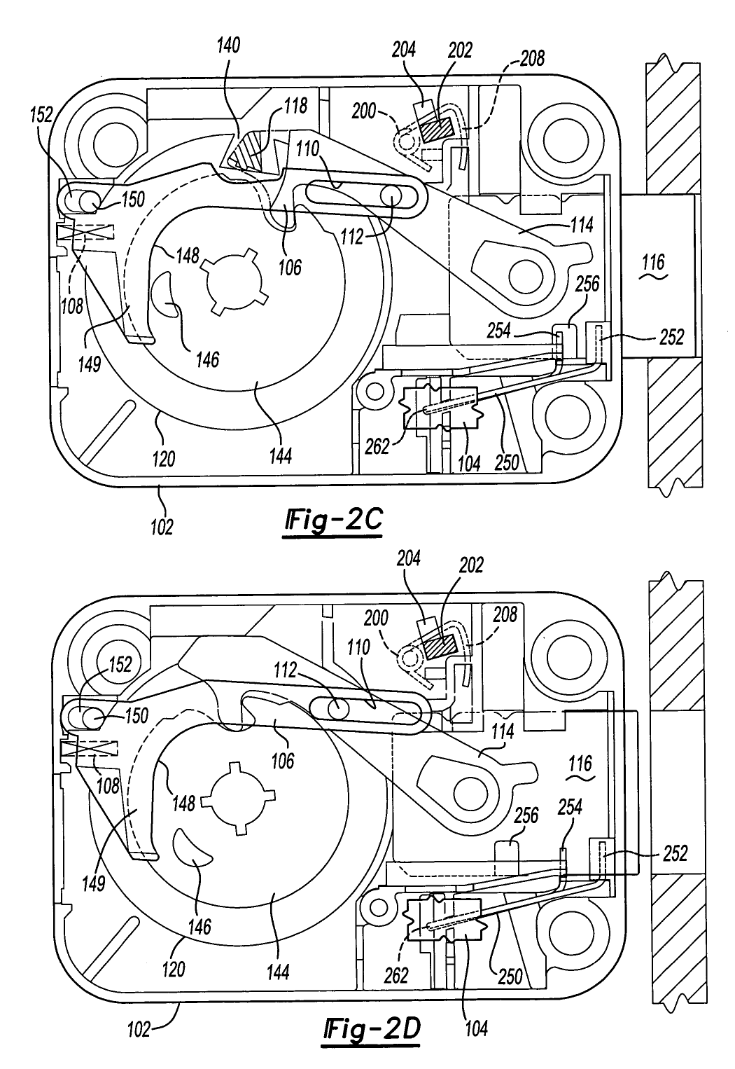

Referring to FIGS. 3 and 5B, if the back cover 104 is displaced or removed from the housing 102 (e.g., in an attempt to pick the lock), the tab 202 withdraws from the slot 204 in the housing, freeing the torsional spring. The biasing force of the spring 200 causes the leg portion 208 of the spring 200 to move into the travel path of the bolt 116, blocking the bolt 116 from moving into the unlocked position even if the gates 140 are aligned with the fence 118 to ordinarily allow unlocking. Thus, any manipulation of the wheels 120 while the back cover 104 is displaced or removed will not allow the lock to be unlocked, even if the lever 114 has dropped down to free the bolt 116. Further, replacing the back cover 104 onto the housing 102 still will not move the leg portion 208 of the spring 200 out of the bolt's path due to the biasing force of the spring 200. In one embodiment, the biasing force of the spring 200 causes the leg portion 208 to drop below the slot 204, making it impossible for the tab 202 to re-engage with the leg portion 208 once the back cover 104 has been displaced. By placing the spring 200 in a recessed portion 206 in the middle of the lock housing 102, the relocking mechanism formed by the spring 200 is much more difficult to access and manipulate with tools.

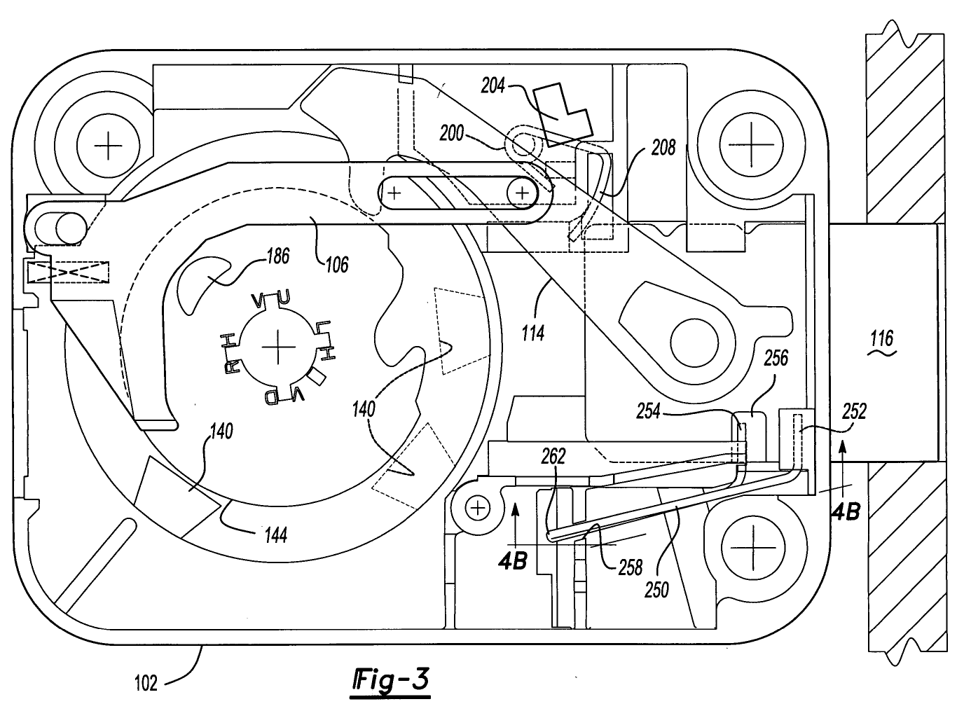

As shown in FIGS. 3, 4A and 4B, the combination lock may include another or an alternative relocking mechanism in the form of a substantially V-shaped linear spring 250 having first and second feet 252, 254 at the ends of the V. Note that the linear spring 250 may have other configurations as well as long as one end of the spring is lifted as the other end is depressed and if the biasing force of the spring is generally orthogonal to the bolt's travel direction. In the illustrated embodiment, the first foot 252 is anchored to the housing 102 and the second foot 254 is biased to fall in the travel path of the bolt 116. The bolt 116 itself has a notch 256 that is aligned with the second foot 254 when the bolt 116 is in the locked position. In one embodiment, the linear spring 250 is disposed in a slot 258 in an interior portion of the housing 102. The slot 258 is disposed generally perpendicular to the travel direction of the bolt 116.

When the back cover 104 is properly attached to the housing 102, a projection 260 on the back cover 104 presses against a contact portion 262 of the linear spring 250. The contact portion 262 is at an end substantially opposite the end of the second foot 254 so that when the contact portion 262 moves downward, the second foot 254 lifts upward. The contact portion 262 and moves downward inside the slot 258 against the spring biasing force of the linear spring 250. When the projection 260 presses downward against the contact portion 262, the second foot 254 lifts out of the path of the bolt 116. Thus, the bolt 116 is able to move between the locked and unlocked positions freely past the second foot 254.

As shown in FIG. 4B, if the back cover 104 is displaced or removed during an attempt to manipulate the lock 100, the projection 260 on the back cover 104 will separate from the contact portion 262 and release the linear spring 250. The biasing force of the linear spring 250 will cause the contact portion 262 of the linear spring 250 move upward, causing the second foot 254 to drop downward into the notch 256 formed in the bolt 116. The engagement of the second foot 254 in the notch 256 immobilizes the bolt 116, making it impossible to move the bolt 116 into the unlocked position.

The slot 258 makes the linear spring 250 virtually inaccessible from any angle except via the projection 260 on the back cover 104. As a result, it is difficult to gain access to the spring 250 with locksmith tools. Moreover, the angle at which the biasing force needs to be applied to lift the second foot 254 is virtually impossible from any direction other than the direction applied by the projection 260. Thus, the spring 250 cannot be biased to allow the bolt 116 to move via tools inserted from the front of the lock through the tube 122.

A given lock may incorporate either the torsional spring 200 or the linear spring 250 as the relocking mechanism. For added security, the lock 100 may incorporate both types of springs 200, 250. Because the springs 200, 250 are disposed in different locations, biased in different directions, engage with the bolt 116 at different locations, and operate independently of each other, incorporating both springs 200, 250 makes the lock 100 extremely difficult to manipulate with tools.

For convenience, it is desirable to allow the lock to open if the operator moves the lock dial slightly (e.g., one-half gradation) off from the intended mark. However, it is also desirable to prevent the lock from opening if the operator dials any part of the combination one full mark or more away from the intended mark, for security reasons. Creating a lock with tolerances that accomplish this can be difficult. Ideally, the tolerances are set to prevent any given wheel from moving when it is not intended to move. Any unintended movement increases the rotational “slop” in the lock, allowing combinations other than the intended combination to open the lock (i.e., “dial span”).

As noted above with respect to FIG. 1, toothed washers 141 may be disposed on the tube 122. Currently known structures form a square tooth on the toothed washer that fits in a square notch (not shown) on the tube 122. This configuration ensures that the toothed washer 141 will easily engage with the notch, but size tolerances between the tooth and the notch creates an air gap that creates rotational slop. Depending on the amount of slop present in the lock and the resulting increased dial span, the actual number of possible combinations that can open the lock due to the slop may increase to undesirable levels.

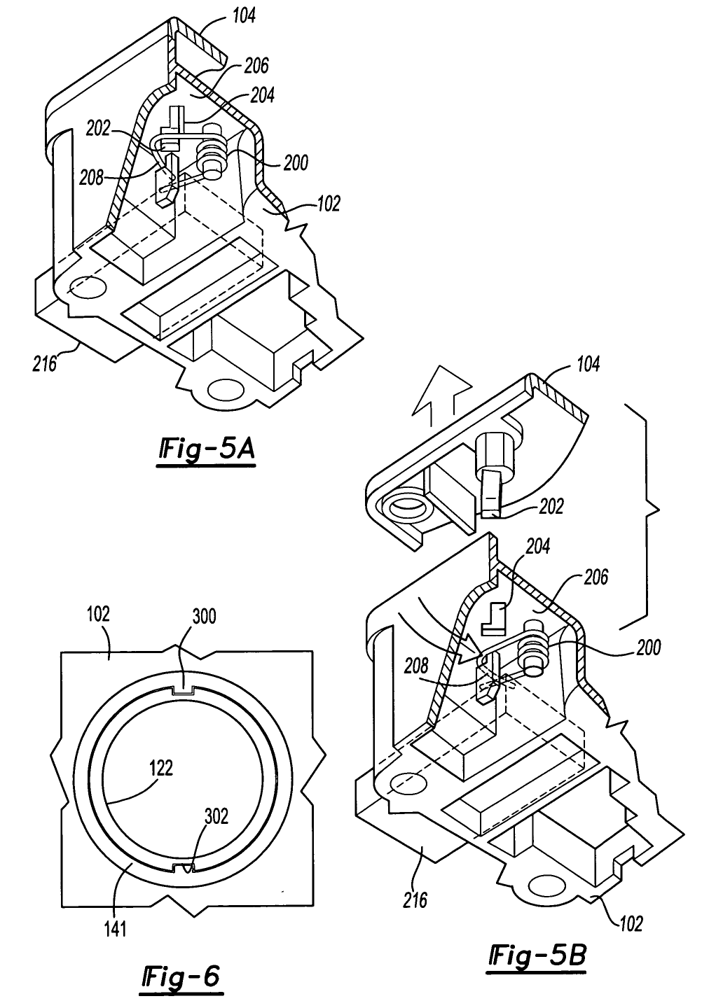

FIG. 6 shows a structure for the toothed washer 141 and the tube 122 to improve security in the lock in greater detail. In this structure, the toothed washer 141 has a trapezoidal tooth 300 that engages a corresponding trapezoidal notch 302 formed on the tube 122 in the lock housing 102 (FIG. 1) to prevent transfer or rotation between wheels 120. The trapezoidal tooth 300 and notch 302 ensure that the tooth 300 can easily and reliably fit within the notch 302 while eliminating the airspace that normally is present between a conventional washer tooth and notch.

In one embodiment, the toothed washer 141 is slightly out of round and is stretched slightly to fit the tube 122, creating a loaded condition on the toothed washer 141. This washer structure eliminates transfer of rotation from one wheel to another, which would ordinarily cause the rotation of an intended wheel to inadvertently rotate another wheel that should remain stationary.

By shaping the tooth 300 on the washer 141 and the notch 302 on the tube 122 as trapezoids, the tooth 300 can easily center itself and fit snugly into the notch 302 with virtually no airspace between the tooth 300 and the notch 302 This snug fit ensures that there is little or no unintended transfer of rotation from one wheel 120 to another as the cam 144 reverses direction while the combination is dialed into the lock. As a result, the inventive tooth and gate structure eliminates rotational slop, tightens the dial span and therefore increases the number of unique settings that the dial can have for a given combination.

All of the above features, either alone or in combination, improve the manipulation resistance of a combination lock and further enhance security.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A combination lock, comprising:
a housing;
a plurality of wheels disposed in the housing, each wheel having a gate;
a cam connected to the wheels to rotate said plurality of wheels, wherein the cam wheel has a roller disposed thereon;
a lever arm having a fence that drops into the gates of said plurality of wheels when the gates are aligned;
a bolt that travels along a travel path between an unlocked position and a locked position, wherein the lever arm releases the bolt from the locked position when the fence drops into the gates;
a rocker arm made of a polymer material and having a curved section with an angled portion at an end contact point; and
a lever arm that is operably connected to the rocker arm.

2. The combination lock of claim 1, further comprising a spring disposed between the housing and the rocker arm to allow both translational and rotational movement of the rocker arm.

3. The combination lock of claim 2, wherein the housing has a pin and the rocker arm has an oval-shaped opening that engages the pin to allow both translation and rotational movement.

4. The combination lock of claim 1, wherein the rocker arm has a slot and the lever arm has a protrusion that engages the slot in the rocker arm.

5. A combination lock, comprising:
a housing;
a plurality of wheels disposed in the housing, each wheel having a gate;
a cam connected to the wheels to rotate said plurality of wheels;
a lever arm having a fence that drops into the gates of said plurality of wheels when the gates are aligned;
a bolt that travels along a travel path between an unlocked position and a locked position, wherein the lever arm releases the bolt from the locked position when the fence drops into the gates;
at least one resilient relocking device, wherein a biasing force in the relocking device biases the relocking device to fall in the travel path of the bolt; and
a back cover having a projection that holds at least a portion of the relocking spring against the biasing force away from the travel path of the bolt when the back cover is attached to the housing.

6. The combination lock of claim 5, wherein the housing has a slot in a front housing surface, and wherein the relocking device is a torsional spring having a leg portion, wherein a biasing force in the torsional spring biases the leg portion to fall in the travel path of the bolt, and
wherein the back cover has a tab that projects into the slot when the back cover is attached to the housing, wherein the tab holds the leg portion against the biasing force in the spring away from the travel path of the bolt when the tab is engaged in the slot.

7. The combination lock of claim 6, wherein the housing has a recessed portion on the front surface, and wherein the torsional spring is disposed in the recessed portion.

8. The combination lock of claim 6, wherein the biasing force in the torsional spring forces the leg portion below the slot when the tab is disengaged from the slot.

9. The combination lock of claim 5, wherein the housing has a slot in an interior portion of the housing, and wherein the relocking device is a linear spring having a first end with a contact portion and a second end opposite the first end,
wherein a biasing force in the linear spring biases the second end to fall in the travel path of the bolt, and
wherein the back cover has a projection that applies a force to the contact portion of the linear spring when the back cover is attached to the housing to push at least a portion of the linear spring into the slot and hold the second end against the biasing force in the spring away from the travel path of the bolt.

10. The combination lock of claim 9, wherein the linear spring is substantially V-shaped and has a first foot and has a second foot at the second end opposite the contact portion, wherein the first foot is connected to the housing and the second foot is biased to fall in the travel path of the bolt.

11. The combination lock of claim 10, wherein the bolt has a notch, and wherein the second foot is biased to fall into the notch.

12. The combination lock of claim 5, wherein the housing has a slot in a front housing surface and a slot in an interior portion of the housing, and wherein said at least one relocking device comprises:
a torsional spring having a leg portion, wherein a biasing force in the torsional spring biases the leg portion to fall in the travel path of the bolt, wherein the back cover has a tab that projects into the slot when the back cover is attached to the housing, wherein the tab holds the leg portion against the biasing force in the spring away from the travel path of the bolt when the tab is engaged in the slot; and
a linear spring having a first end with a contact portion and a second end opposite the first end, wherein a biasing force in the linear spring biases the second end to fall in the travel path of the bolt, and wherein the back cover has a projection that applies a force to the contact portion of the linear spring when the back cover is attached to the housing to push at least a portion of the linear spring into the slot and hold the second end against the biasing force in the spring away from the travel path of the bolt.

13. A combination lock, comprising:
a housing having a slot in an interior portion of the housing and a pin;
a plurality of wheels disposed in the housing, each wheel having a gate;
a cam connected to the wheels to rotate said plurality of wheels, wherein the cam wheel has a roller disposed thereon;
a lever arm having a bar that drops into the gates of said plurality of wheels when the gates are aligned;
a bolt that travels along a travel path between an unlocked position and a locked position, wherein the lever arm releases the bolt from the locked position when the bar drops into the gates;
a rocker arm made of a polymer material and having a curved section with an angled portion at an end contact point, wherein the rocker arm has a slot and an oval-shaped opening;
a spring disposed between the housing and the rocker arm, wherein the oval-shaped opening engages the pin on the housing to allow both translation and rotational movement of the rocker arm;
a lever arm having a protrusion that engages the slot in the rocker arm to operably connect the lever arm to the rocker arm;
a torsional spring having a leg portion, wherein a biasing force in the torsional spring biases the leg portion to fall in the travel path of the bolt;
a linear spring having a first end with a contact portion and a second end opposite the first end, wherein a biasing force in the linear spring biases the second end to fall in the travel path of the bolt;
a back cover having a tab that projects into the slot and a projection that applies a force to the contact portion of the linear spring when the back cover is attached to the housing, wherein the tab holds the leg portion against the biasing force in the spring away from the travel path of the bolt when the tab is engaged in the slot and wherein the projection pushes at least a portion of the linear spring into the slot and hold the second end against the biasing force in the spring away from the travel path of the bolt.

14. The combination lock of claim 13, wherein the housing has a recessed portion on the front surface, and wherein the torsional spring is disposed in the recessed portion.

15. The combination lock of claim 14, wherein the biasing force in the torsional spring forces the leg portion below the slot when the tab is disengaged from the slot.

16. The combination lock of claim 13, wherein the linear spring is substantially V-shaped and has a first foot and a second foot at the second end opposite the contact portion, wherein the first foot is connected to the housing and the second foot is biased to fall in the travel path of the bolt.

17. The combination lock of claim 16, wherein the bolt has a notch, and wherein the second foot is biased to fall into the notch.

18. A combination lock, comprising:
a housing with a tube having at least one trapezoidal notch;
a plurality of wheels disposed in the housing and supported by the tube;
a cam connected to the wheels to rotate said plurality of wheels, wherein the cam wheel has a roller disposed thereon;
a lever arm having a bar that drops into the gates of said plurality of wheels when the gates are aligned;
a bolt that travels along a travel path between an unlocked position and a locked position, wherein the lever arm releases the bolt from the locked position when the bar drops into the gates; and
at least one toothed washer, each toothed washer having a trapezoidal tooth that engages said at least one trapezoidal notch in the tube.
